(19) United States
(12) Patent Application Publication
(10) Pub. No.: US 2005/0025602 A1
(43) Pub. Date: Feb. 3, 2005

(54) Expansion screw

(76) Inventor: Kun-Tsung Huang, Yongkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/628,335

(22) Filed: Jul. 29, 2003

(51) Int. Cl. F16B 1/00

(52) U.S. Cl. 411/57.1

(57) ABSTRACT

An expansion screw includes an expansion sleeve, and an expanding block; the sleeve has elongated gaps extending lengthwise from a tail end, and engaging portions on an inner side; the expanding block has a screw hole, and is in the shape of a truncated cone formed with outer engaging portions for fitting the inner engaging portions of the sleeve; a screw is passed through the sleeve, and screwed into the smaller end of the expanding block with the block smaller end being passed into the sleeve tail end; thus, when the screw is further turned, the block will be made to pass into the sleeve to expand the sleeve; the outer engaging portions engage respective ones of the inner engaging portions such as to prevent angular displacement of the expanding block relative to the expansion sleeve, and helping the expanding block move into the expansion sleeve.

### BACKGROUND OF THE INVENTION

1. Field of the invention

The present invention relates to an expansion screw, more particularly one including an expansion sleeve, and an expanding block, which expansion sleeve is formed with a head for engagement with a spanner, and an inner side shaped in such a manner that the expanding block won't turn relative to the expansion sleeve in vain when a screw is used to make the expanding block move lengthways in the expansion sleeve to expand the expansion sleeve.

2. Brief Description of the Prior Art

Expansion screws are usually used for securing objects in position, e.g. hollow bricks, iron plates, RC floors, and stone parts, or fastening objects to each other. Referring to FIG. 10, a conventional expansion screw 4 includes a screw 41, an expansion sleeve 44, and an expanding tube 45. The expansion sleeve 44 is formed with cylindrical outer and inner sides, and has elongated expansion gaps 441 at a tail end. The expanding tube 45 has a cylindrical outer side, and screw threads on an inner side thereof, and can be fitted into the tail end of the expansion sleeve 44. To use the expansion screw, the screw 41 is passed through ringed pads 42, 43, and the expansion sleeve, and is screwed into the expanding tube 45, and the expansion screw is passed into holes of objects to be fastened to each other. Then, the screw 41 is turned to make the expanding tube 45 move further into the expansion sleeve 44; thus, the tail end of the expansion sleeve 44 is expanded, and firmly joined to the objects to be fastened.

The expansion screw is found to have disadvantages as followings:
1. When the screw 41 is being turned, the expansion sleeve 44 is prone to turn relative to the objects to be fastened because it is cylindrical. Consequently, the expanding tube 45 can't be effectively passed further into the sleeve 44.
2. When the screw 41 is being turned, the expanding tube 45 is prone to turn relative to the expansion sleeve 44 because both the inner side of the sleeve 44 and the outer side of the tube 45 are cylindrical. Consequently, the expanding tube 45 can't be passed further into the sleeve 44.

### SUMMARY OF THE INVENTION

It is a main object of the present invention to provide an expansion screw to overcome the above disadvantages.

The expansion screw includes an expansion sleeve, and an expanding block for the sleeve. The sleeve has elongated gaps extending lengthwise from a tail end, and engaging portions on an inner side. The expanding block has a screw hole, and is in the shape of a truncated cone formed with outer engaging portions for fitting the inner engaging portions of the sleeve. A screw is passed through the sleeve, and screwed into the smaller end of the block with the block smaller end being passed into the sleeve tail end; the outer engaging portions engage respective ones of the inner engaging portions such as to prevent angular displacement of the expanding block relative to the expansion sleeve; thus, when the screw is further turned, the block will be made to pass into the sleeve to expand the sleeve. The inner engaging portions of the sleeve can be flat surfaces or lengthwise extending elongated trenches while the outer engaging portions of the block can be flat surfaces or elongated protrusions capable of fitting into the elongated trenches.

### BRIEF DESCRIPTION OF THE DRAWINGS

The present invention will be better understood by referring to the accompanying drawings, wherein:

FIG. 1 is an exploded perspective view of the expansion screw of the first embodiment of the present invention,

FIG. 2 is an exploded perspective view of the expansion screw of the second embodiment,

FIG. 3 is a cross-sectional view of the expansion screw of the first embodiment,

FIG. 4 is an exploded perspective view of the expansion screw of the third embodiment,

FIG. 5 is a cross-sectional view of the expansion screw of the third embodiment,

FIG. 6 is an exploded perspective view of the expansion screw of the fourth embodiment,

FIG. 7 is a cross-sectional view of the expansion screw of the fourth embodiment,

FIG. 8 is an exploded perspective view of the expansion screw of the fifth embodiment,

FIG. 9 is a cross-sectional view of the expansion screw of the fifth embodiment, and

FIG. 10 is an exploded perspective view of the conventional expansion screw as described in the Background.

### DETAILED DESCRIPTION OF THE PREFERRED EMBODIMENTS

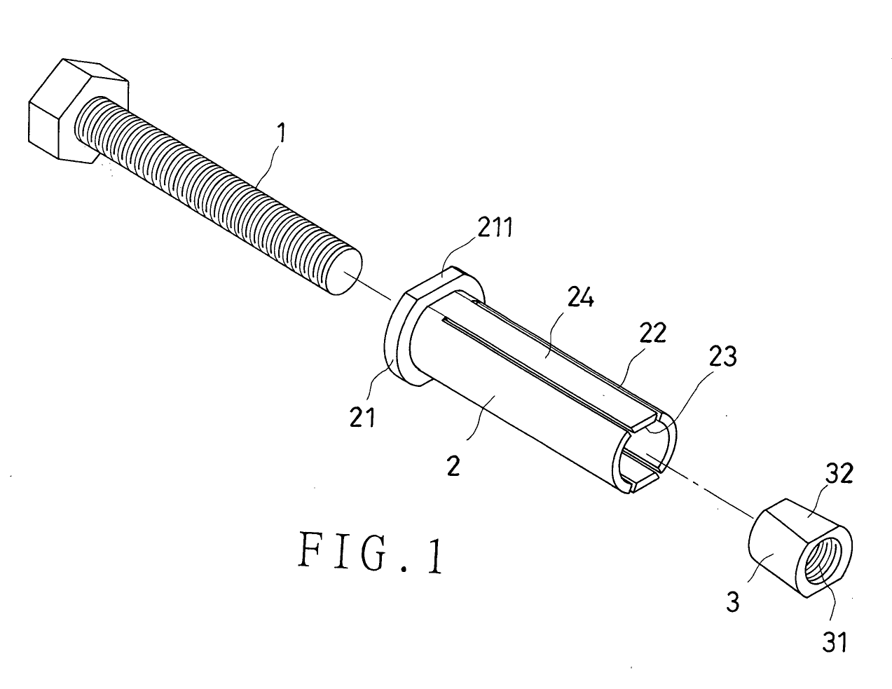

Referring to FIG. 1, a first embodiment of an expansion screw in the present invention includes a screw 1, an expansion sleeve 2, and an expanding block 3. The expansion sleeve 2 has a main body, and an engaging head 21 formed on a front end of the main body. The main body has several elongated gaps 22 extending lengthwise from a tail end thereof, and elongated sections separated by the elongated gaps 22; two opposing ones of the elongated sections are formed with two inner flat surfaces 23, and two outer flat surfaces 24. The expanding block 3 has a screw hole 31, and is in the shape of a truncated cone having a smaller front end and a larger tail end, and formed with two outer flat sides 32 facing opposite directions. The outer flat sides 32 are parallel to each other as well as the central axis of the expanding block 3. In other words, the outer flat sides 32 are horizontal when the expanding block 3 is laid down on a horizontal surface.

To use the expansion screw, the screw 1 is passed through the expansion sleeve 2, and is screwed into the expanding block 3 with the expanding block 3 being partially fitted into the tail end of the expansion sleeve 2 at a smaller end of the block 3, and with the outer flat sides 32 facing respective ones of the inner flat sides 23. And, the whole expansion screw is passed into holes of objects to be fastened to each other, and a spanner is engaged with the engaging head 21 of the sleeve 2 to hold the sleeve 2 in position. Then, the screw 1 is turned to make the expanding block 3 move further into the expansion sleeve 2; thus, the expansion sleeve 2 is expanded by the block 3, and firmly joined to the objects to be fastened to each other.

Because the outer flat sides 32 of the expanding block 3 are faced with respective inner flat sides 23 of the expansion sleeve 2, the expanding block 3 can't possibly turn relative to the expansion sleeve 2 when the screw 1 is being turned, and screwed into it. In other words, it is not possible for the user to turn the screw 1 in vain in using the present expansion screw to fasten objects to each other.

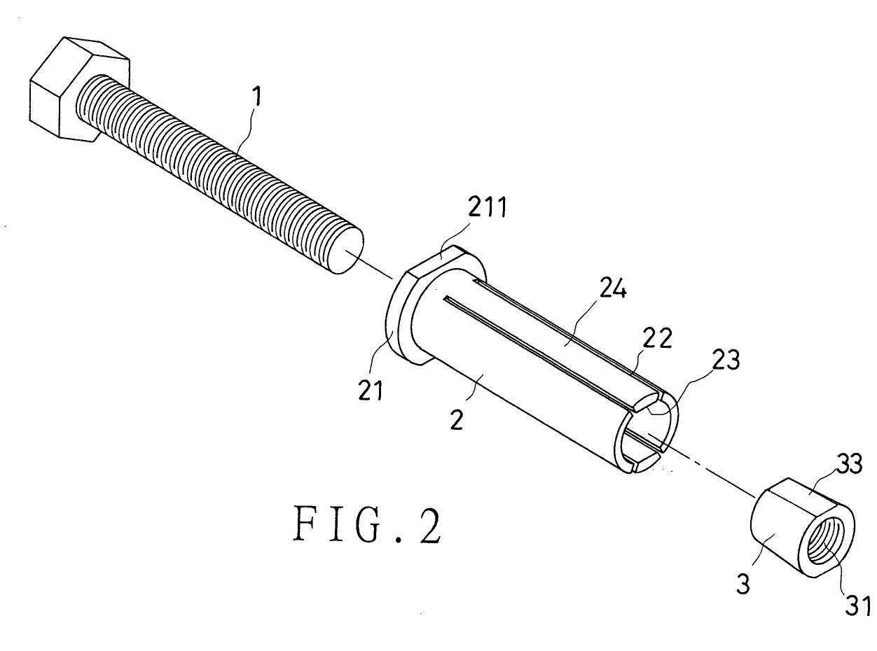

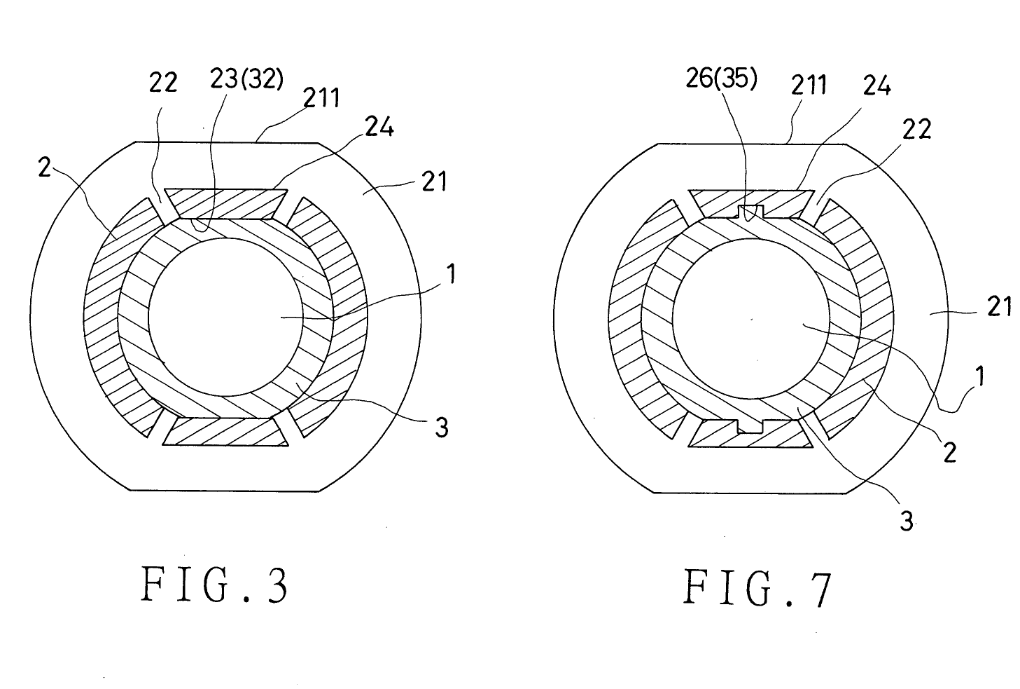

Referring to FIG. 2, expansion sleeve 2 of a second embodiment in the invention is formed with curved surfaces 25 instead of the flat surfaces 24 on outer sides of two opposing sections thereof while expanding block 3 is in the shape of a truncated cone formed with two outer flat sides 33, which face opposite directions, and which preferably slope in such a manner that the front ends thereof are nearer to the central axis of the expanding block 3 than the tail ends thereof.

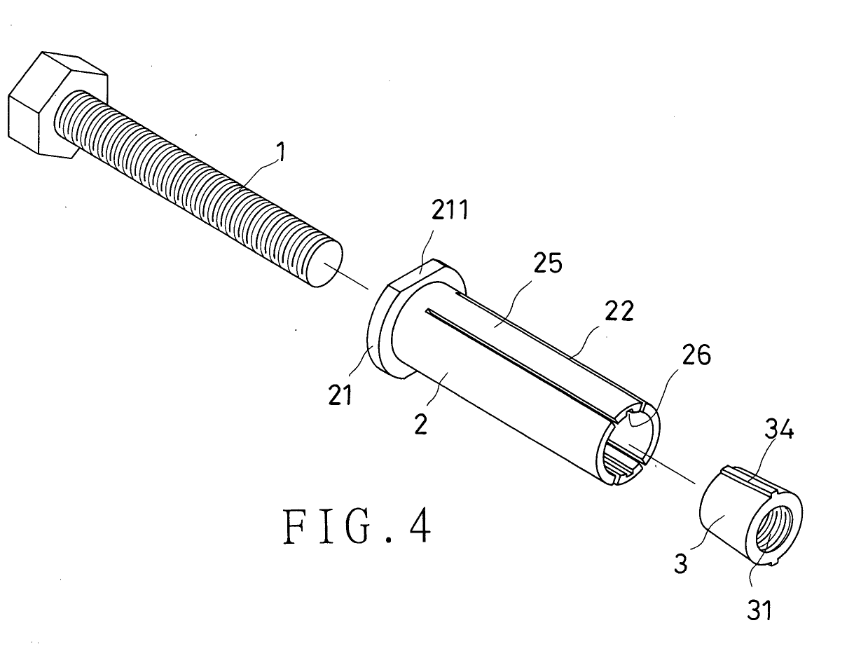

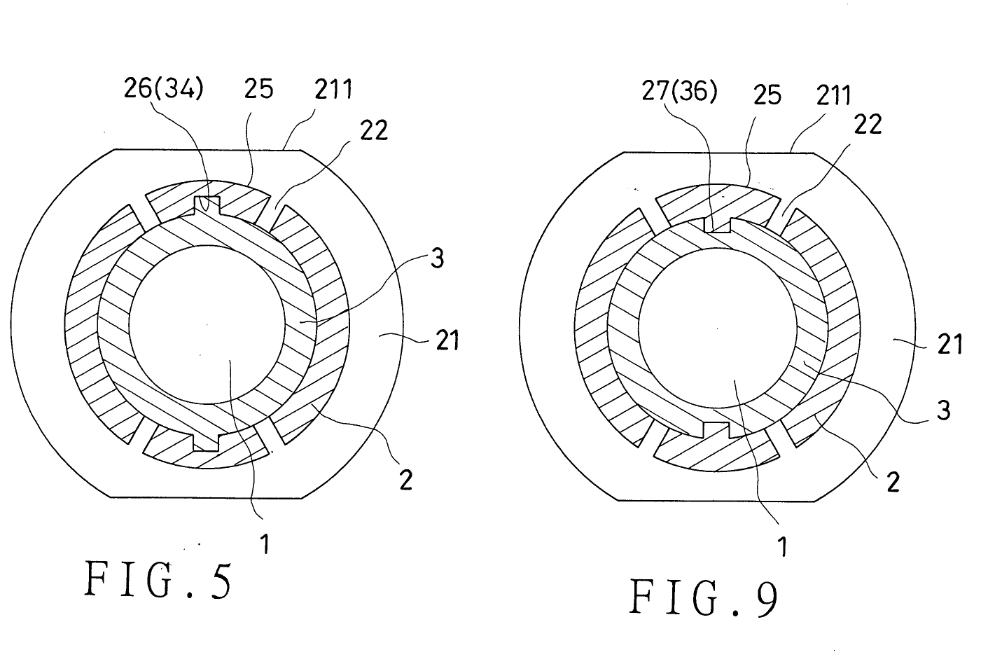

Referring to FIG. 4, expansion sleeve 2 of a third embodiment in the invention has two elongated engaging trenches 26 lengthwise formed on inner sides of the two opposing sections thereof while expanding block 3 is in the shape of a truncated cone having two elongated engaging protrusions 34 lengthwise formed on the outer side, which elongated engaging protrusions 34 preferably slope in such a manner that the front ends thereof are nearer to the central axis of the expanding block 3 than the tail ends thereof. Thus, when the screw 1 is being turned to make the expanding block 3 further pass into the expansion sleeve 2, the engaging protrusions 34 can fit into the engaging trenches 26 to prevent the block 3 from turning relative to the sleeve 2, as shown in FIG. 5.

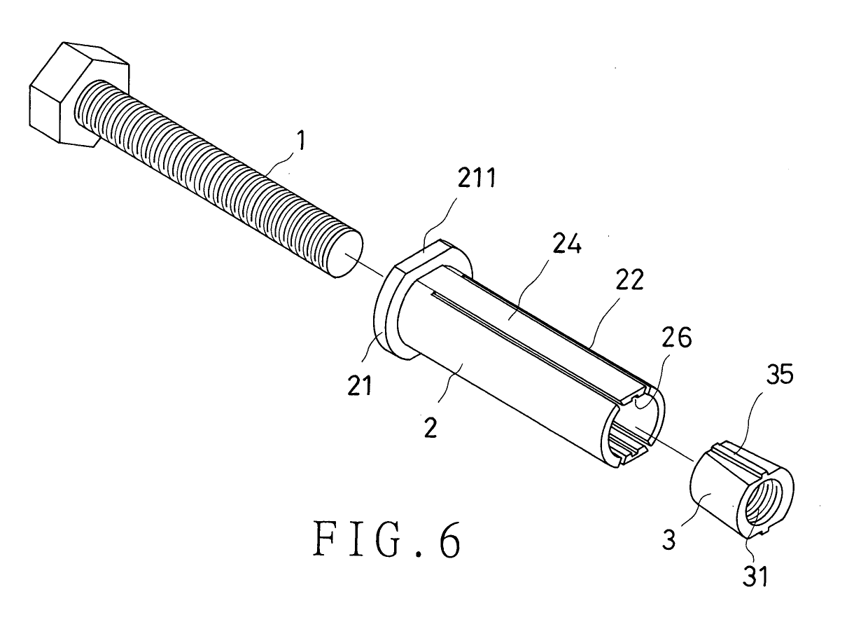

Referring to FIG. 6, expansion sleeve 2 of a fourth embodiment in the invention has flat surfaces on inner sides of two opposing sections thereof, and has two elongated engaging trenches 26 lengthwise formed on inner sides of the two opposing sections while expanding block 3 is in the shape of a truncated cone formed with two outer flat sides facing opposite directions. The expanding block 3 further has two elongated engaging protrusions 35 lengthwise formed on the outer flat sides thereof, and parallel to each other as well as the central axis of the block 3. Thus, when the screw 1 is being turned to make the expanding block 3 further pass into the expansion sleeve 2, the engaging protrusions 35 can fit into the engaging trenches 26 to prevent the block 3 from turning relative to the sleeve 2, as shown in FIG. 7.

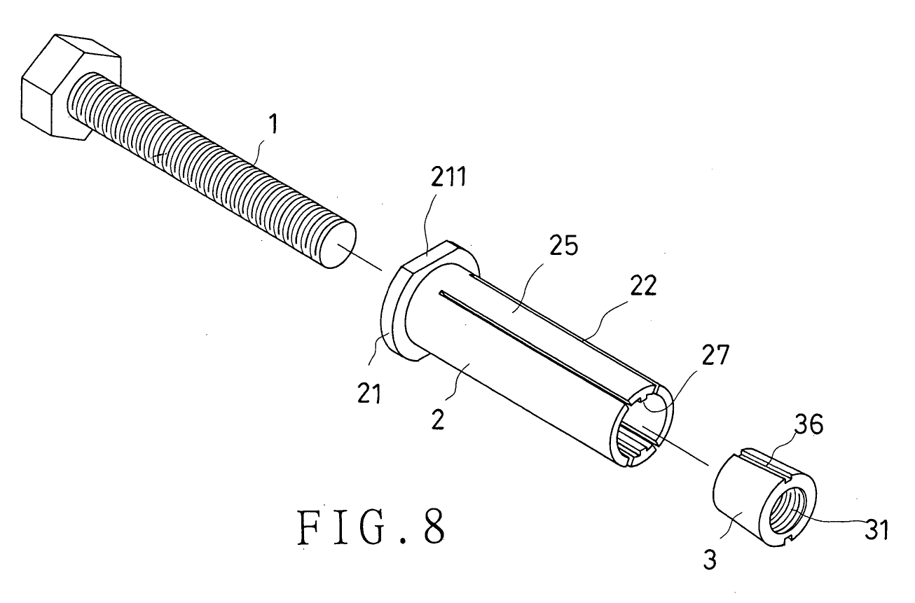

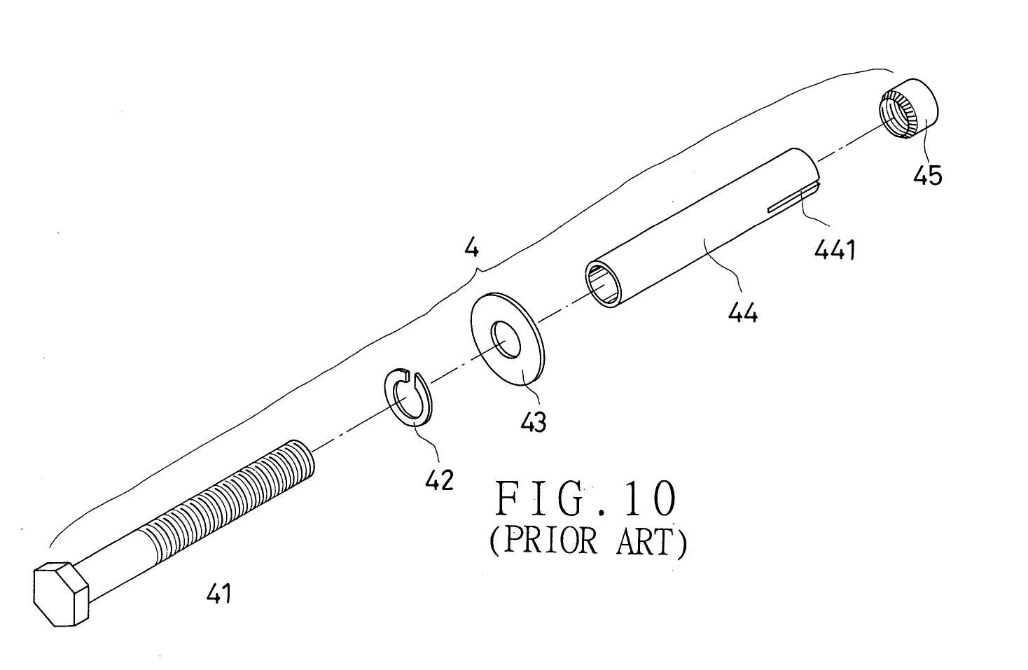

Referring to FIG. 8, expansion sleeve 2 of a fifth embodiment in the invention has two elongated engaging protrusions lengthwise formed on inner sides of the two opposing sections while expanding block 3 is in the shape of a truncated cone having two elongated engaging trenches 36 lengthwise formed on the outer side, which elongated engaging trenches 36 preferably slope in such a manner that the front ends thereof are nearer to the central axis of the expanding block 3 than the tail ends thereof. Thus, when the screw 1 is being turned to make the expanding block 3 further pass into the expansion sleeve 2, the engaging protrusions 27 of the sleeve 2 can fit into the engaging trenches 36 of the expanding block 3 to prevent the block 3 from turning relative to the sleeve 2, as shown in FIG. 9.

From the above description, it can be easily understood that the expansion screw of the present invention has advantages as followings:
1. The sleeve 2 can be prevented from turning by means of a spanner engaged with the engaging head 21 of the sleeve 2 when the screw is being turned to move the expanding block 3 further into the sleeve 2 so as to expand the sleeve 2.
2. The expanding block 3 can be effectively prevented from turning relative to the expansion sleeve 2. Therefore, it is not possible for a user to turn the screw in vain in using the present expansion screw to fasten objects to each other.

1. An improvement on an expansion screw, comprising
a screw;
an expansion sleeve having an engaging head formed on a front end thereof; the engaging head being shaped such as to allow a spanner to be engaged therewith to hold the expansion sleeve still; the expansion sleeve having a plurality of elongated gaps extending lengthwise from a tail end thereof; the expansion sleeve having a plurality of engaging portions on an inner side thereof;
an expanding block having a screw hole for allowing the screw to be screwed therein; the expanding block being in a shape of a truncated cone formed with a smaller front end and a larger tail end; the expanding block having outer engaging portions for fitting the inner engaging portions of the expansion sleeve;
the screw being passed through the sleeve and screwed into the expanding block with the front smaller end of the expanding block being at least partially passed into the tail end of the expansion sleeve, and with the outer engaging portions of the expanding block engaging respective inner engaging portions of the expansion sleeve in such a manner as to prevent angular displacement of the expanding block relative to the expansion sleeve, thus capable of making the block further pass into the sleeve to expand the sleeve by screwing thereof through the screw.

2. The expansion screw as claimed in claim 1, wherein each of the inner engaging portions of the expansion sleeve is formed with a flat surface while each of the outer engaging portions of the expanding block is formed with a flat surface; the flat engaging portions being parallel to a central axis of the expanding block.

3. The expansion screw as claimed in claim 1, wherein each of the inner engaging portions of the expansion sleeve is formed with a flat surface while each of the outer engaging portions of the expanding block is formed with a sloping flat surface.

4. The expansion screw as claimed in claim 1, wherein each of the inner engaging portions of the expansion sleeve has an elongated engaging trench lengthwise formed thereon while each of the outer engaging portions of the expanding block has a sloping elongated engaging protrusion lengthwise formed thereon for fitting in a respective one of the elongated engaging trenches of the sleeve.

5. The expansion screw as claimed in claim 1, wherein each of the inner engaging portions of the expansion sleeve has an elongated engaging trench lengthwise formed thereon while each of the outer engaging portions of the expanding block has an elongated engaging protrusion lengthwise formed thereon for fitting in a respective elongated engaging trench of the sleeve; the elongated engaging protrusions being parallel to a central axis of the expanding block.

6. The expansion screw as claimed in claim 1, wherein each of the inner engaging portions of the expansion sleeve has an elongated engaging protrusion lengthwise formed thereon while each of the outer engaging portions of the expanding block has a sloping elongated engaging trench lengthwise formed thereon for fitting over a respective one of the elongated engaging protrusions of the sleeve.

7. The expansion screw as claimed in claim 1, wherein each of the inner engaging portions of the expansion sleeve has an elongated engaging protrusion lengthwise formed thereon while each of the outer engaging portions of the expanding block has an elongated engaging trench lengthwise formed thereon for fitting over a respective elongated engaging protrusion of the sleeve; the elongated engaging trenches being parallel to a central axis of the expanding block.

8. The expansion screw as claimed in claim 1, wherein the expansion sleeve has flat outer surfaces corresponding to the inner engaging portions thereof.

9. The expansion screw as claimed in claim 1, wherein the expansion sleeve has curved outer surfaces corresponding to the inner engaging portions thereof.
